(19) United States
(12) Patent Application Publication
(10) Pub. No.: US 2012/0294002 A1
(43) Pub. Date: Nov. 22, 2012

(54) VAPOR CHAMBER COOLING OF SOLID-STATE LIGHT FIXTURES

(75) Inventor: Scott Igl, Portland, OR (US)

(73) Assignee: Phoseon Technology, Inc., Hillsboro, OR (US)

(21) Appl. No.: 13/110,842

(22) Filed: May 18, 2011

(51) Int. Cl. F21S 4/00; F21V 29/00

(52) U.S. Cl. 362/249.01

(57) ABSTRACT

A lighting module has an array of light emitters, a heat sink having a first surface, the array of light emitters being mounted to the first surface, a vapor chamber inside the heat sink, the vapor chamber including a liquid and arranged to absorb heat from the first surface until the liquid becomes vapor, and a cooling unit thermally coupled to a second surface of the heat sink opposite the first.

### BACKGROUND

Solid-state light emitting devices, such as light-emitting diodes (LEDs) and laser diodes, have become more common in curing applications such as those using ultra-violet light. Solid-state light emitters have several advantages over traditional mercury arc lamps including that they use less power, are generally safer, and are cooler when they operate.

However, even though they generally operate at cooler temperatures than arc lamps, they do generate heat. Since the light emitters generally use semiconductor technologies, extra heat causes leakage current and other issues that result in degraded output. Management of heat in these devices has become important.

One traditional cooling technique uses a heat sink, which generally consists of thermally conductive materials mounted to the substrates upon which the light emitters reside. Some sort of cooling or thermal transfer system generally interacts with the back side of the heat sink, such as heat dissipating fins, fans, liquid cooling, etc., to draw the heat away from the light emitter substrates. The efficiency of these devices remains lower than desired, and liquid cooling systems can complicate packaging and size restraints.

### BRIEF DESCRIPTION OF THE DRAWINGS

FIG. 1 shows an embodiment of a solid-state light fixture having vapor chamber cooling.

FIG. 2 shows a cut view of an LED-based light fixture having vapor chamber cooling.

FIG. 3 shows an embodiment of a solid-state light fixture having vapor chamber cooling with a liquid-cooled structure.

### DETAILED DESCRIPTION OF THE EMBODIMENTS

Several approaches exist for cooling LED and other solid-state light fixtures including air and liquid cooled systems. Air cooled systems typically involve a heat sink, generally a piece of thermally conductive material like aluminum or copper, mounted to the back side of the substrate or substrates of the arrays of light emitting elements. Heat generated by the solid-state or semiconductor light emitting elements transfers through the thermally conductive heat sink out the back side of the module, away from the elements. This process may be assisted by the user of fins on the back side of the heat sink, and air circulation, such as with a fan.

Liquid cooled systems typically involve a liquid enclosed in some sort of vessel that traverses the back side of the array of elements. The liquid receives the heat from the array and moves it to another area where some sort of cooler removes the heat so that when the liquid returns to the back side of the array, it can accept more heat. The cooler may consist of a refrigeration unit through which the liquid moves. The cooler may also consist of air cooling systems, but the overall system relies upon liquid for heat transfer and is therefore considered a liquid cooling system.

While both of these options provide a solution to the problems of cooling solid-state light fixtures, they have problems. Air cooled systems typically do not provide as high a level of cooling as desired. These systems may run a little ‘hot’ reducing the efficiency and effectiveness of the light fixtures. Liquid cooled systems typically have complicated packaging requirements to accommodate both the liquid channels, which must be sealed so as to not damage the electronics, and the cooling system to cool the liquid.

Another viable option involves using a vapor chamber type cooling system in the place of a traditional heat sink. A vapor chamber may take many forms, but a common form includes a chamber ‘inside’ the heat sink. The chamber typically has three regions. A first region is the transportation region in which a liquid resides. A vaporization region may have a wicking material within it to wick the liquid away from the region in which the heat from the arrays transfers. Finally, a condensation region typically resides the furthest away from the heat transfer/transportation region.

As the liquid turns to gas in the transportation region, the vaporization region moves the gas to the condensation region. As the gas cools and returns to liquid form, it moves back through the vaporization region into the transportation region.

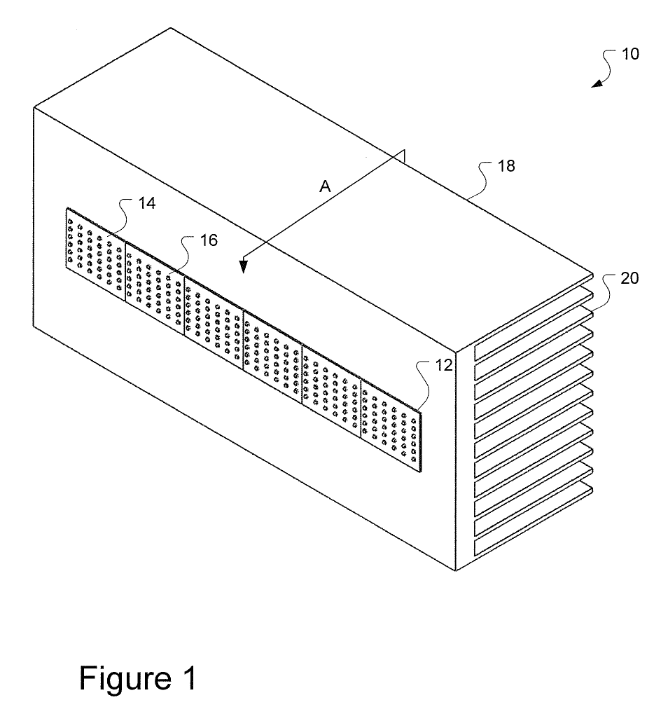

FIG. 1 shows an embodiment of a vapor chamber cooled solid-state light module. The light module 10 has an array 12 of individual light emitting elements formed into an array. The array may reside on one substrate, or may consist of several smaller arrays each on individual substrates, such as 14 and 16, but the term array used here will encompass both possibilities. The light module may also include control electronics and optics, not shown.

The array 12 mounts to the front face of the heat sink 18, possibly with a thermal interface material, like thermal grease. The heat sink appears in this view to consist of a traditional heat sink, typically a large block of thermally conductive material such as copper, aluminum, or brass, with cooling structures 20. In this embodiment, the cooling structures 20 consist of fins for an air cooled heat sink, but may instead consist of liquid cooled or other air cooling features like a fan with or without the fins, typically arranged on the surface of the heat sink opposite the surface upon which the light emitters reside.

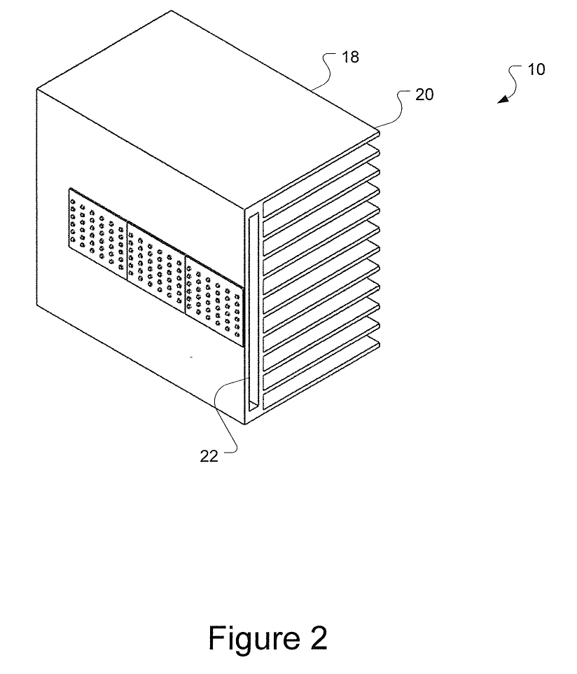

If one were to cut the heat sink 18 along the section line A, the resulting view appears in FIG. 2. As can be seen in FIG. 2, the heat sink 18 is revealed to include a vapor chamber 22. The vapor chamber 22 contains the liquid and the three zones mentioned above. The liquid will generally consist of water, although other liquids such as alcohol, ethylene glycol, of a fluorocarbon-based fluid may be used. The liquid should have good wicking properties and not be too viscous. The vapor chamber 22 may also be pressurized to lower the boiling point of the liquid to increase the efficiency of the system.

The vapor chamber appears to be like any other heat sink, except that it may have a slightly greater thickness to accommodate the chamber. This allows for a smaller profile than other liquid cooled systems, but still provides the higher thermal transfer characteristics than a typical air-cooled system.

In typical heat sinks, the fins towards the center of the heat sink end up receiving most of the heat from the light emitters. This limits the amount of heat that the heat sink dissipates because the fins that receive most of the heat have much smaller surface area than the surface area of all of the fins. The fins towards the top and the bottom of the heat sink, as oriented in the drawing, become essentially unused.

By employing a vapor chamber inside the heat sink, these fins become part of the heat dissipation path. The vapor expands and fills the chamber as it moves away from the heat source, so the heat is more evenly distributed against the second surface of the heat sink. This utilizes the fins that were previously unused. Advantages of this include allowing the heat source to run at higher temperatures than previous, since more heat will be dissipated, and the ability to have heat sinks that are much larger than the heat source. One could have a large heat sink with several fins that extend well beyond the size of the heat source. Without the vapor chamber, the extra fins would add no benefit.

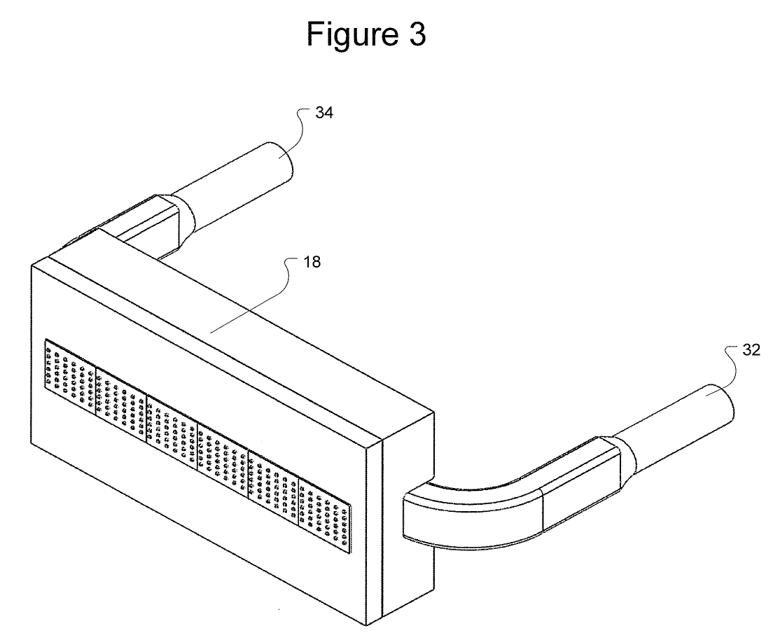

In some instances, higher cooling requirements may benefit from use of a water or other liquid cooling approach. FIG. 3 shows an embodiment of this approach. The heat sink 18, with the interior vapor chamber, is mounted to a pipe. The pipe has an inlet pipe portion 34 that circulates cool water or other liquid from a cooler unit, not shown. The cool liquid traverses the backside of the heat sink 18, removing the heat from the vapor chamber. As mentioned above, this will cause the vapor to return to liquid state and move back towards the surface of the heat sink adjacent to the array of light-emitting elements. The liquid moves away from the heat sink 18 by outlet pipe 32. Outlet pipe 32 then passes the liquid to the cooling unit, where it is cooled and then re-circulated to the heat sink. The cooling unit may take one of many forms including a fan, a refrigeration unit, etc.

There has been described to this point a particular embodiment for a vapor chamber cooled light module, with the understanding that the examples given above are merely for purposes of discussion and not intended to limit the scope of the embodiments or the following claims to any particular implementation.

What is claimed is:

1. A lighting module, comprising:
an array of light emitters;
a heat sink having a first surface, the array of light emitters being mounted to the first surface;
a vapor chamber inside the heat sink, the vapor chamber including a liquid and arranged to absorb heat from the first surface until the liquid becomes vapor; and
a cooling unit thermally coupled to a second surface of the heat sink opposite the first surface.

2. The lighting module of claim 1, wherein the array of light emitters comprises at least one substrate having multiple light emitters arranged on the substrate.

3. The lighting module of claim 2, wherein the array of light emitters comprises multiple substrates, the substrates being one of either stacked in both a vertical and horizontal direction or stacked in a horizontal direction.

4. The lighting module of claim 1, wherein the array of light emitters comprises a single line of emitters.

5. The lighting module of claim 1 wherein the heat pipe comprises one of copper, aluminum or brass.

7. The lighting module of claim 1, wherein the liquid comprises one of water, alcohol, ethylene glycol, or fluorocarbon-based fluid.

8. The lighting module of claim 1, wherein the cooling unit comprises a fan configured to blow air across at least a portion of the second surface.

9. The lighting module of claim 1, wherein the cooling unit comprises one of either ridges or fins on at least a portion of the second surface.

10. The lighting module of claim 1, wherein the cooling unit comprises a liquid cooling unit having a pipe mounted to the second surface.

11. The lighting module of claim 1, wherein the array of light emitters is mounted to the heat sink using a thermal interface material.

12. The lighting module of claim 1, wherein the array of light emitters is mounted to at least one substrate and the substrate is mounted to the heat sink.
